(19) United States
(12) Patent Application Publication
(10) Pub. No.: US 2026/0243870 A1
(43) Pub. Date: Aug. 20, 2026

(54) OPTICAL STRUCTURE FOR COHERENT DETECTION BEAM COMBINER

(71) Applicant: STMicroelectronics International N.V., Geneva (CH)

(72) Inventor: Matteo Fissore, Edinburgh (GB)

(21) Appl. No.: 19/053,995

(22) Filed: Feb. 14, 2025

(51) Int. Cl. G01S 7/481; G01S 17/10; G01S 17/58

(52) U.S. Cl. CPC G01S 7/4811; G01S 7/4817; G01S 17/10; G01S 17/58

(57) ABSTRACT

An example coherent detection beam combiner system, an optical structure for combining beams, and a method for detecting pulses in a returning optical signal at a coherent detection beam combiner system are provided. The example system includes an optical transmitter, an optical receiver, and a beam combiner optical structure. The optical structure is positioned between the optical transmitter and a target object, and is configured to receive a transmitted optical signal. A first optical region transmits a first portion of the transmitted optical signal through the optical structure toward the target object, and internally reflects a second portion within the optical structure. A second optical region transmits the returning optical signal reflected off the target object to the optical receiver, and transmits the second portion of the transmitted optical signal out of the optical structure, toward the optical receiver, as a reference optical signal.

### TECHNOLOGICAL FIELD

Embodiments of the present disclosure relate generally to coherent detection beam combiners, and more particularly, to an optical structure configured to combine a reference beam and a returning beam at a coherent detection beam combiner system.

### BACKGROUND

Optical ranging sensors, including light detection and ranging (LiDAR) applications, have become increasingly prevalent in a wide range of applications due to their ability to provide precise, high resolution measurements of a three-dimensional environment and object detection. For example, in the automotive industry, optical ranging sensors are a key technology for autonomous operations on vehicles, enabling them to detect and avoid obstacles while navigating complex environments. Optical ranging sensors additionally play a crucial role in the operation of unmanned aerial vehicles (UAVs), in geo-mapping applications, in consumer electronics, and in robotics. The versatility and accuracy of optical ranging sensors in varying conditions has made them an indispensable tool in both research and commercial applications.

In some optical ranging sensor applications, pulse detection is enabled by coherent detection techniques. Applicant has identified many technical challenges and difficulties associated with combining signals in a coherent detection beam combiner system. Through applied effort, ingenuity, and innovation, Applicant has solved problems related to combining signals by developing solutions embodied in the present disclosure, which are described in detail below.

### BRIEF SUMMARY

Various embodiments are directed to an example coherent detection beam combiner system, an optical structure for combining beams, and a method for detecting pulses in a returning optical signal at a coherent detection beam combiner system.

An example coherent detection beam combiner system may comprise an optical transmitter, an optical receiver, and a beam combiner optical structure. The optical transmitter configured to transmit a transmitted optical signal toward a target object. The optical receiver configured to receive a returning optical signal reflected off the target object and a reference optical signal. The beam combiner optical structure positioned between the optical transmitter and the target object, and configured to receive the transmitted optical signal. The beam combiner optical structure comprising a first optical region and a second optical region. The first optical region configured to transmit a first portion of the transmitted optical signal through the beam combiner optical structure toward the target object, and internally reflect a second portion of the transmitted optical signal within the beam combiner optical structure. The second optical region configured to transmit the returning optical signal reflected off the target object to the optical receiver, and transmit the second portion of the transmitted optical signal out of the beam combiner optical structure, toward the optical receiver, as the reference optical signal.

In some embodiments, the first optical region and the second optical region each comprise an optical metasurface.

In some embodiments, the first portion of the transmitted optical signal is collimated.

In some embodiments, the second portion of the transmitted optical signal is directed by the first optical region at a refraction angle larger than a total internal reflection limit for the beam combiner optical structure.

In some embodiments, the second optical region directs the second portion of the transmitted optical signal at an opposite refraction angle relative to the refraction angle, such that the reference optical signal is propagated orthogonally relative to the beam combiner optical structure.

In some embodiments, the reference optical signal and the returning optical signal are both focused towards the optical receiver by the second optical region.

In some embodiments, the transmitted optical signal is a frequency-modulated continuous-wave signal.

In some embodiments, the coherent detection beam combiner system further comprises a scanning mechanism configured to scan the first portion of the transmitted optical signal across a field-of-view.

In some embodiments, the beam combiner optical structure comprises a first surface proximate the optical transmitter, and a second surface opposite the first surface.

In some embodiments, the first optical region and the second optical region are both positioned on the first surface.

In some embodiments, the second surface of the beam combiner optical structure comprises the first optical region, and the first surface of the beam combiner optical structure comprises the second optical region.

In some embodiments, the beam combiner optical structure further comprises a first end and a second end. The first end proximate the first optical region and the second end proximate the second optical region, wherein the first optical region directs the first portion of the transmitted optical signal toward the first end, and wherein the first portion of the transmitted optical signal experiences an even number of reflections within the beam combiner optical structure before arriving at the second optical region.

In some embodiments, the first end of the beam combiner optical structure further comprises a reflective coating.

In some embodiments, the first end is non-orthogonal to the first surface.

In some embodiments, the coherent detection beam combiner system further comprises a patterned reflecting coating. The patterned reflecting coating on the second surface patterned such that the second portion of the transmitted optical signal intersects the patterned reflective coating, the first portion of the transmitted optical signal does not intersect the patterned reflective coating, and at least a portion of the returning optical signal is received through the second surface at the second optical region, wherein the second portion of the transmitted optical signal is reflected by the patterned reflective coating.

In some embodiments, the coherent detection beam combiner system further comprises an optical coating on the second surface, wherein a transmittance value of the optical coating varies according to an angle of incidence of an incident optical signal, wherein the second portion of the transmitted optical signal is reflected by the optical coating, and wherein the first portion of the transmitted optical signal is transmitted through the optical coating.

In some embodiments, the first optical region of the beam combiner optical structure is further configured to generate a plurality of transmitted optical beams comprising the first portion of the transmitted optical signal, and a plurality of reflected optical beams comprising the second portion of the transmitted optical signal, wherein the returning optical signal comprises a plurality of returning optical beams, the optical receiver of the coherent detection beam combiner system further comprising a plurality of regions, wherein each region of the plurality of regions simultaneously receives at least one pair comprising a returning optical beam of the plurality of reflected optical beams and a reference optical beam of the plurality of reflected optical beams, wherein the at least one pair is combined in an independent, mode-matched signal at the second optical region, and directed toward a corresponding region of the plurality of regions.

In some embodiments, the coherent detection beam combiner system further comprises an aperture stop positioned in a path of the returning optical signal.

An example beam combiner optical structure is further provided. In some embodiments, the example beam combiner optical structure comprises a first optical region and a second optical region. The first optical region configured to transmit a first portion of a transmitted optical signal received at the first optical region through the beam combiner optical structure toward a target object, and internally reflect a second portion of the transmitted optical signal within the beam combiner optical structure. The second optical region configured to transmit a returning optical signal reflected off the target object through the beam combiner optical structure, and transmit the second portion of the transmitted optical signal out of the beam combiner optical structure.

An example method for detecting pulses in a returning optical signal reflected off a target object is further provided. In some embodiments, the example method comprising providing a beam combiner optical structure comprising a first optical region and a second optical region; receiving a transmitted optical signal at the first optical region of the beam combiner optical structure; transmitting a first portion of the transmitted optical signal through the beam combiner optical structure toward the target object, wherein the first portion of the transmitted optical signal is collimated; internally reflecting a second portion of the transmitted optical signal at an angle of diffraction within the beam combiner optical structure; receiving at the second optical region the returning optical signal reflected off the target object; focusing the returning optical signal at an optical receiver; receiving the second portion of the transmitted optical signal at the second optical region; focusing the second portion of the transmitted optical signal at the optical receiver such that the returning optical signal and the second portion of the transmitted optical signal are combined in a mode matched signal; converting a light intensity of the mode matched signal into an electronic signal by an optical detector and associated circuitry; and detecting a pulse in the mode matched signal.

### BRIEF DESCRIPTION OF THE DRAWINGS

Reference will now be made to the accompanying drawings. The components illustrated in the figures may or may not be present in certain embodiments described herein. Some embodiments may include fewer (or more) components than those shown in the figures in accordance with an example embodiment of the present disclosure.

FIG. 1 illustrates a reference optical signal in an example coherent detection beam combiner system in accordance with an example embodiment of the present disclosure.

FIG. 2 illustrates a returning optical signal in a coherent detection beam combiner system in accordance with an example embodiment of the present disclosure.

FIG. 3A-FIG. 4E illustrate example configuration for a beam combining optical structure in accordance with an example embodiment of the present disclosure.

FIG. 5 illustrates an example scanning mechanism configured to scan a transmitted optical signal from a coherent detection beam combiner system in accordance with an example embodiment of the present disclosure.

FIG. 6 illustrates an example coherent detection beam combiner system with a separated collimator in accordance with an example embodiment of the present disclosure.

FIG. 7 illustrates an example configuration for a beam combining optical structure configured to generate and receive multiple beams in accordance with an example embodiment of the present disclosure.

FIG. 8 depicts an example process for detecting pulses in a returning optical signal in accordance with an example embodiment of the present disclosure.

### DETAILED DESCRIPTION

Example embodiments will be described more fully hereinafter with reference to the accompanying drawings, in which some, but not all embodiments of the inventions of the disclosure are shown. Indeed, embodiments of the disclosure may be embodied in many different forms and should not be construed as limited to the embodiments set forth herein; rather, these embodiments are provided so that this disclosure will satisfy applicable legal requirements. Like numbers refer to like elements throughout.

Various example embodiments address technical problems associated with combining a reference optical signal and a return optical signal, particularly in a coherent detection beam combiner system. As understood by those of skill in the field to which the present disclosure pertains, there are numerous example scenarios in which it may be desirable to efficiently combine a reference optical signal and a return optical signal.

For example, many devices utilize optical ranging sensors to determine the location and motion of objects in a surrounding environment based on returned light reflected off one or more target objects. Devices include robotic devices (e.g., robotic vacuums, robotic mops, robotic lawn mowers, etc.), smart speakers (e.g., virtual assistant), motion detect lights, motion detect cameras, household appliances, smart thermostats, motor vehicles, and so on. Such devices may utilize optical ranging sensors to detect presence, proximity, motion, and/or distance of surrounding objects nearby the device. The devices may perform an action based on the detected presence of a target object. For example, a robotic device may avoid a detected object, a smart speaker or virtual assistant may communicate based on the presence of a detected object, a motion detect light may turn on based on the presence or motion of an object, a motor vehicle may take action to regulate its speed and attitude, and so on.

Coherent detection is a common technique utilized by optical ranging sensors for determining position and speed of target objects in an environment. Coherent detection involves transmitting a target signal and a reference signal from an optical source. The target signal is transmitted into an external environment to reflect off targets in the external environment and return to a receiving sensor. Simultaneously, the reference signal is transmitted directly to the receiving sensor. The reflected return signal and the reference signal are mixed coherently at the receiving sensor. Based on the characteristics of the mixed signal, the optical ranging sensor may determine the position and speed of target objects in the external environment.

Frequency-modulated continuous-wave (FMCW) coherent detection is a particular coherent detection technique used by many optical ranging sensor systems. In FMCW coherent detection, an optical source transmits a continuous wave (e.g., transmitted optical signal) that is frequency modulated over time, typically in a linear chirp pattern. A transmitted portion of the transmitted optical signal interacts with objects in the environment. At the same time, a reference portion of the transmitted optical signal is reflected back to an optical receiver. By mixing the returning optical signal with the reference optical signal derived from the same optical source, the optical ranging sensor system may measure the frequency difference between the returning optical signal and the reference optical signal. The frequency difference is directly related to the range and velocity of the target object in the external environment.

One of the main challenges of designing a ranging optical sensor based on coherent detection is mode-matching. Mode-matching requires the returning optical signal and the reference optical signal beams to have the same wavefront shape (i.e. the same mode), to minimize the formation of spatial interference fringes and/or speckle patterns at the sensor. The reduction of interference fringes and speckle is important in order to retain a good signal to noise ratio (SNR) of the demodulated signal, resulting in accurate final ranging performance of the device. The system performance is also related to the pixel size of the detector used, namely the presence of spatial fringes with period Λ or speckle patterns with characteristic speckle diameter D at the sensor constrains the detector pixel size to be of the order of or smaller than Λ or D; where this is not the case, the amplitude of the coherent (temporal) signal containing range and velocity information is severely reduced. Conversely, if the reference and return beams are well mode-matched, the amplitude of the coherent signal is maximized, and detectors with arbitrary pixel geometries may be used.

Some previous coherent detection optical ranging system examples utilize various optical structures to split and recombine the transmitted optical signal from the optical source. These optical structures require precise alignment. Any misalignment may result in an offset spatial mode and spatial interference. Similarly, various previous examples may utilize optical fibers to split and transmit a reference signal. However, the optical fibers are bulky which may be unsuitable for many applications. Finally, various previous examples may utilize photonic integrated circuits (PiC) to split and recombine the light; however, this brings challenges in terms of system integration, available central wavelengths at which to operate the device, and maximum optical power rating.

The various example embodiments described herein provide a single beam combiner optical structure configured to split the reference optical signal from a transmitted optical signal, and recombine the reference optical signal with a returning optical signal reflected off a target object in an external environment. In some embodiments, the beam combiner optical structure comprises two optical regions configured on a surface of the beam combiner optical structure. A transmission side optical region (e.g., first optical region) may be configured at or near the optical transmitter. The transmission side optical region may be configured to receive the transmitted optical signal and split the transmitted optical signal into a first portion which is transmitted through the beam combiner optical structure toward a target object; and a second portion, which is refracted at a refraction angle within the beam combiner optical structure. The refraction angle may be large enough that the second portion of the transmitted optical signal experiences total internal reflection within the beam combiner optical structure; alternatively, the second portion of the transmitted optical signal may simply reflect off a surface of the beam combiner optical structure. The transmitter side may also simultaneously apply a collimating lensing effect to the incoming beam, such that the outgoing and reference beams be collimated, or have a pre-specified wavefront shape.

In addition, the beam combiner optical structure may include a receiver side optical region (e.g., second optical region) configured at or near an optical receiver of the optical ranging system. The receiver side optical region may be configured to transmit the internally reflected second portion of the transmitted optical signal at an opposite refraction angle. Thus, transmitting the second portion of the transmitted optical signal out of the beam combiner optical structure orthogonal to the surface of the beam combiner optical structure comprising the receiver-side optical region.

Further, the receiver side optical region is configured to simultaneously receive the returning optical signal reflected off one or more target objects in an external environment. The receiver side optical region is configured to focus both the returning optical signal and the reference optical signal toward the optical receiver. As the transmitter side optical structure ensures that the reference beam has a specific wavefront shape, be it collimated or otherwise, it is possible to ensure it matches the incoming wavefront from the external environment. The receiver side optical region ensures the two signals are mode matched, meaning the optical signal beams have the same wavefront shape. By ensuring the two signals are mode matched, a coherent detection system may detect changes to the returning optical signal due to interactions with a target object, usually by detecting the constructive and destructive interference resulting by a phase shift between the reference and return signals, and/or the temporal variation (temporal frequency) of the above-mentioned interference signal.

As a result of the herein described example embodiments, the manufacture of a beam combiner optical structure of a coherent detection optical ranging system may be simplified. For example, utilizing a single optical component may simplify the manufacture of the beam combiner optical structure. Further, in some embodiments, the transmission optical region and the receiving optical region may be patterned on a single surface of the beam combiner optical structure, enabling the use of a single mask or nanoimprint tool. Further, in some embodiments, the surface opposite that where the transmission optical region and the receiving optical region may be uniformly coated or left bare, thus not requiring additional patterning and saving the manufacturer the expense and complexity of creating and aligning patterns on two opposite surfaces of the optical structure. In addition, the single beam combiner optical structure may reduce the overall size of a beam combiner in a coherent detection optical ranging system. Further, manufacture of the single beam combiner optical structure may be cheaper and less complex than other previous multi-structure examples. In some embodiments, the transmission optical region and the receiving optical region may be aligned using photolithography techniques with sensible tolerance limits on the thickness of the beam combiner optical structure thickness and slope error. Alignment using photolithography techniques ensures high accuracy of the geometric dimensions of the beam combiner optical structure and the transmitter and receiving optical regions, resulting in good mode matching between the reference optical signal and the returning optical signal. Further, any misalignment in the beam combiner optical structure in the x and y dimensions affects both the transmitter and receiving optical regions equally. Thus, the mode matching is not disturbed, reducing the need for complex and costly active alignment of the beam combiner to the underlying light source and detector.

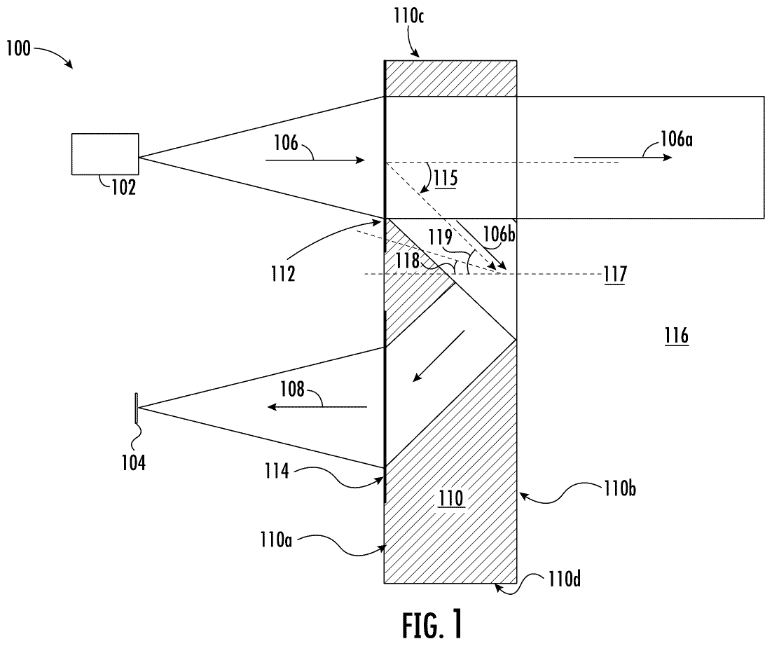

Referring now to FIG. 1, an example coherent detection beam combiner system 100 is provided. As depicted in FIG. 1, the example coherent detection beam combiner system 100 includes an optical transmitter 102, an optical receiver 104, and a beam combiner optical structure 110. The optical transmitter 102 is configured to transmit a transmitted optical signal 106 toward a transmission optical region 112 of the beam combiner optical structure 110. A transmitted portion 106a (e.g., first portion) of the transmitted optical signal 106 is transmitted through the beam combiner optical structure 110 into an external environment 116. A reference portion 106b (e.g., second portion) of the transmitted optical signal 106 is refracted at the transmission optical region 112 such that the reference portion 106b is internally reflected within the beam combiner optical structure 110. As further depicted in FIG. 1, the beam combiner optical structure 110 comprises a receiving optical region 114 on the same surface (e.g., inner surface 110a) of the beam combiner optical structure 110. The receiving optical region 114 is configured to receive the reference portion 106b of the transmitted optical signal 106 and transmit the reference portion 106b out of the beam combiner optical structure 110 toward the optical receiver 104 as a reference optical signal 108.

As used herein, the term “coherent detection beam combiner system” refers to any detection system configured to utilize coherent detection techniques, including beam combining, in order to determine one or more physical properties of a target object. With coherent detection techniques, information about the target object may be encoded into the phase, intensity, and/or amplitude of the light returning from the target object. To analyze the information contained in the returning light, the returning light is mixed with a reference signal (e.g., reference portion 106b of the transmitted optical signal 106) which provides a phase reference. The mixed signal (e.g., returning light and reference signal) may then be processed to determine the physical properties of the target object based on the properties of the returning light. In some embodiments, a coherent detection beam combiner system may carry two different channels of information, for example, in two different polarizations of light.

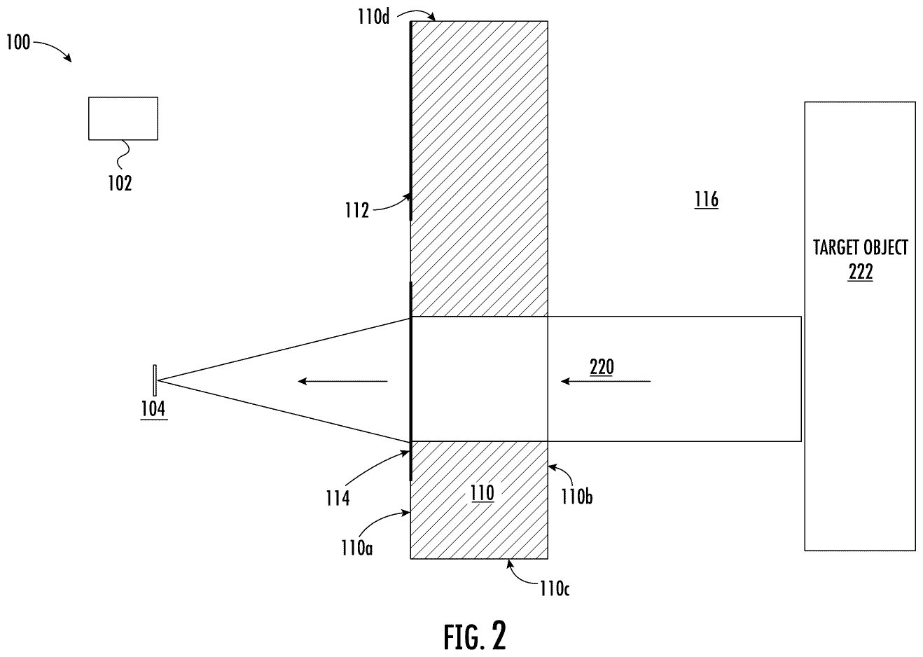

As depicted in FIG. 1, the coherent detection beam combiner system 100 may comprise an optical ranging sensor configured to determine a physical characteristic of a target object in an external environment 116 based on combining a reference optical signal 108 with a returning optical signal (e.g., returning optical signal 220 described in relation to FIG. 2) reflected off a target object in an external environment 116. In general, coherent detection operates by merging a plurality of optical beams, for example, the returning optical signal and the reference optical signal. In an instance in which the beams are aligned in phase, the interference pattern of the merged optical signals provides information related to a physical position and/or motion of the target object. Utilizing coherent detection in an optical ranging sensor may improve detection of weak returning optical signals, and enable high-resolution measurements.

In some embodiments, the coherent detection beam combiner system 100 may utilize a frequency-modulated continuous-wave (FMCW) transmitted optical signal 106 to determine the physical characteristics of target objects in the external environment 116. In coherent detection based on FMCW, the optical transmitter 102 transmits a continuous wave that is frequency modulated over time, typically in a linear chirp pattern. The reference portion 106b of the transmitted optical signal is reflected back to the optical receiver 104. While, the transmitted portion 106a is transmitted into the external environment 116. In a coherent detection system, the returning optical signal is mixed with the reference optical signal 108 derived from the reference portion 106b. By mixing the returning optical signal with the reference optical signal 108 derived from the same optical source, the optical ranging sensor system may measure the frequency difference between the returning optical signal and the reference optical signal 108. The frequency difference is directly related to the range and velocity of the target object in the external environment 116.

In some embodiments, the coherent detection beam combiner system 100 may comprise a light detection and ranging (LiDAR) system. A LiDAR system utilizes laser light to measure physical characteristics of a target object. For example, in a LiDAR system, the optical transmitter 102 is configured to generate a coherent laser beam toward a target object in the external environment 116.

As further depicted in FIG. 1, the example coherent detection beam combiner system 100 includes an optical transmitter 102. An optical transmitter 102 is any device, bulb, semiconductor, light emitting diode, laser, or other photon-emitting structure configured to generate a transmitted optical signal 106. An optical transmitter 102 may comprise any light source, such as a laser diode, a light-emitting diode, bulb, semiconductor device, or other photon-emitting structure. In some embodiments, an optical transmitter 102 may comprise a semiconductor laser diode, for example, a vertical-cavity surface-emitting laser (VCSEL) and/or an edge emitting laser diode.

In general, the transmitted optical signal 106 may be generated by the optical transmitter 102 upon receipt of an electrical current. The transmitted optical signal 106 may comprise a coherent light beam. In some embodiments, the optical transmitter 102 may be configured to generate a frequency-modulated transmitted optical signal 106 by continuously updating the frequency of the transmitted optical signal 106. As depicted in FIG. 1, the transmitted optical signal 106 is transmitted toward the transmission optical region 112 on the inner surface 110a of the beam combiner optical structure 110.

As further depicted in FIG. 1, the example coherent detection beam combiner system 100 includes an optical receiver 104. An optical receiver 104 is any set of one or more photodiodes, integrated circuits, devices, sensors, light sensing diodes, or other photodetector structures that produce an electric signal based on the light received at the optical receiver 104. For example, the electric signal output by the optical receiver 104 may increase as the number of photons that strike the optical receiver per second increases. In such an embodiment, the electric current output from the optical receiver 104 may be used to determine the intensity or amplitude of the optical radiation striking the optical receiver. In some embodiments, the optical receiver 104 may be a light sensitive semiconductor diode that creates an electron-hole pair at the p-n junction when a photon of sufficient energy strikes the optical receiver. In some embodiments, the optical receiver may comprise one or more single-photon avalanche diodes (SPADs) configured to generate an avalanche current when one or more photons strike the optical receiver.

The electrical signal generated by the optical receiver 104 may be used to determine the interference pattern of the merged optical signals (e.g., the reference optical signal 108 and the returning optical signal). The interference pattern may be used to determine one or more characteristics of a target object in an external environment 116. For example, the interference pattern may be utilized to determine the position and/or speed of a target object.

Although not depicted, a coherent detection beam combiner system 100 may further include processing circuitry. Processing circuitry may be configured to analyze the interference pattern based on the electrical signal generated by the optical receiver 104. The processing circuitry may further be configured to determine the characteristics of target objects in the external environment 116 based on the electrical signal.

As further depicted in FIG. 1, the example coherent detection beam combiner system 100 includes a beam combiner optical structure 110. A beam combiner optical structure 110 comprises any transparent optical structure configured to enable the transmission of at least a portion (e.g., transmitted portion 106a) of the transmitted optical signal 106. The beam combiner optical structure 110 is further defined by a geometric configuration. The geometric configuration of the beam combiner optical structure 110 defines the number, size, and shape of each of the faces (e.g., surfaces) of the beam combiner optical structure 110. In addition, the geometric configuration defines the angles of each of the faces of the beam combiner optical structure 110 relative to each other. For example, as depicted in FIG. 1, the depicted beam combiner optical structure 110 comprises a rectangular prism three-dimensional geometric configuration.

A beam combiner optical structure 110 comprises at least an inner surface 110a (e.g., first surface), an outer surface 110b (e.g., second surface), a transmission end 110c, and a receiver end 110d. The inner surface 110a comprises the surface of the beam combiner optical structure 110 closest to the optical transmitter 102.

As depicted in FIG. 1, the inner surface 110a comprises both the transmission optical region 112 and the receiving optical region 114, however, in one or more embodiments, the transmission optical region 112 and/or the receiving optical region 114 may be disposed on another surface of the beam combiner optical structure 110.

The outer surface 110b comprises the surface of the beam combiner optical structure 110 opposite the inner surface 110a. In some embodiments, the outer surface 110b may be the surface of the beam combiner optical structure 110 proximate to, or closest to the external environment 116. As depicted in FIG. 1, the transmitted portion 106a of the transmitted optical signal 106 passes out of the beam combiner optical structure 110 through the outer surface 110b. As further depicted in FIG. 1, the reference portion 106b of the transmitted optical signal 106 is reflected by the outer surface 110b of the beam combiner optical structure 110. As depicted in FIG. 1, the outer surface 110b is parallel to the inner surface 110a.

The transmission end 110c of the beam combiner optical structure 110 comprises the end of the beam combiner optical structure 110 proximate the optical transmitter 102. As depicted in FIG. 1, the transmission optical region 112 is proximate the transmission end 110c of the beam combiner optical structure 110. As further depicted in FIG. 1, the transmission end 110c of the beam combiner optical structure 110 is orthogonal to the inner surface 110a and the outer surface 110b of the beam combiner optical structure 110.

The receiver end 110d of the beam combiner optical structure 110 comprises the end of the beam combiner optical structure 110 proximate the optical receiver 104. As depicted in FIG. 1, the receiving optical region 114 is proximate the receiver end 110d of the beam combiner optical structure 110. As further depicted in FIG. 1, the receiver end 110d of the beam combiner optical structure 110 is orthogonal to the inner surface 110a and the outer surface 110b of the beam combiner optical structure 110.

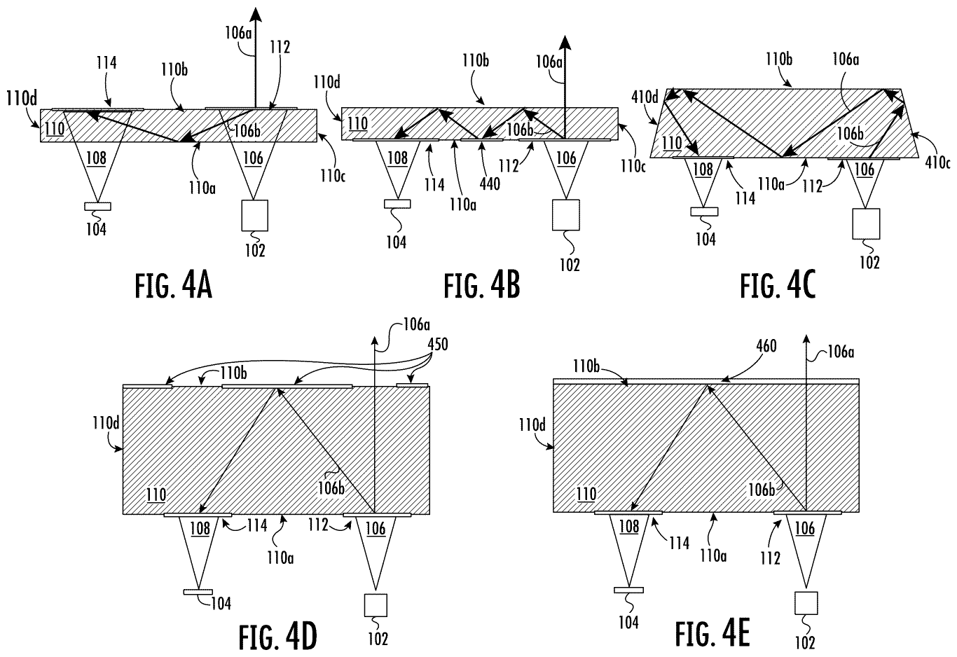

In some embodiments, one or more sides and/or ends of the geometric configuration of the beam combiner optical structure 110 may be configured at one or more oblique angles, for example, as described in reference to FIG. 4C.

The beam combiner optical structure 110 further enables total internal reflection of at least a portion (e.g., reference portion 106b) of the transmitted optical signal 106. Total internal reflection occurs when an optical signal traveling in a medium (e.g., beam combiner optical structure 110) strikes a boundary of the medium (e.g., outer surface 110b) at an incident angle 119 greater than the critical angle 118 of the medium boundary. An incident angle 119 is the angle at which an optical signal encounters the medium boundary, relative to the normal 117 of the medium boundary. The critical angle 118 is the threshold angle relative to the normal of the medium boundary below which an incident optical signal is reflected and above which, the incident optical signal is refracted. As depicted in the example of FIG. 1, the incident angle 119 of the reference portion 106b of the transmitted optical signal 106 is greater than the critical angle 118 of the medium boundary, thus, the reference portion 106b of the transmitted optical signal 106 is reflected within the beam combiner optical structure 110, when the boundary between the beam combiner optical structure 110 and the external environment 116 is encountered. The critical angle 118 depicted in FIG. 1 is for illustrative purposes only.

As further depicted in FIG. 1, the beam combiner optical structure 110 comprises a transmission optical region 112 (e.g., first optical region) and a receiving optical region 114 (e.g., second optical region). An optical region comprises any modification, alteration, or addition to a surface (e.g., inner surface 110a) of the beam combiner optical structure 110, defining the optical properties of the beam combiner optical structure 110 relative to incident light. In some embodiments, an optical region may utilize diffractive optic techniques to direct an incident optical beam based on polarization, amplitude, wavelength, frequency, angle of incidence, and the like. For example, a refraction angle through the optical region may vary based on polarization.

In some embodiments, the optical region may comprise a optical metasurface. An optical metasurface comprises a regular array of miniature nanostructures that act as local phase retarders on the surface of the optical component (e.g., beam combiner optical structure 110. A range of phase retardation may be achieved based on the geometric structure of the nanostructures. For example, changing the diameter of cylindrical nanostructures may alter the phase shift experienced by transmitted light. By selectively altering the phase of incident light using the nanostructures across the optical metasurface, transmitted light may utilize diffractive properties to generate a diffractive transmitted light pattern.

A nanostructure of an optical metasurface is any pillar, column, cylinder, or other structure on the surface of an optical metasurface comprising a high refractive index material compared to a surrounding low refractive index material, such that incident light encountering a first end of the nanostructure is transmitted through the nanostructure. In some embodiments, the nanostructure may comprise silicon, while the surrounding material comprises silicon dioxide. The dimensions of the nanostructure defines the phase retardation of the incident light transmitted through the nanostructure. Phase retardation is the phase offset introduced by the nanostructure. For example, in some instances a nanostructure may cause a phase offset between 0 and 2π.

In an instance in which the nanostructure is cylindrical or near cylindrical, the phase retardation may be defined based on the diameter of the nanostructure. Full phase freedom from 0 to 2π may be achieved by adjusting the diameter of the cylindrical nanostructure without changing the height of the nanostructure. Achieving full phase freedom without changing the height of the nanostructure is particularly useful in an creating a low profile optical device.

In addition, nanostructures may strongly confine energy locally when compared to other diffractive optic devices. Confined energy through the nanostructures results in a more efficient optical device, as generated and/or received light is not scattered and/or reflected.

An optical region may be configured to generate a diffractive transmitted light pattern based on the nanostructures of an optical metasurface. A diffractive transmitted light pattern is any light output pattern resulting from the transmission of incident light (e.g., transmitted optical signal 106) through the nanostructures of the optical metasurface. Transmitted light through each of the nanostructures may experience various shifts in phase. Phase shifts from different nanostructures may result in constructive and destructive interference patterns. The constructive and destructive interference may result in various diffractive transmitted light patterns. For example, as depicted in FIG. 1, an optical region may be configured to generate constructive interference for a portion of the transmitted optical signal (e.g., transmitted portion 106a) at a particular angle (e.g., refraction angle 115), while a second portion of the transmitted optical signal passes through the beam combiner optical structure 110 with no refraction angle.

In some embodiments, an optical metasurface may be formed on a surface of the beam combiner optical structure 110 using photolithographic processes. For example, the nanostructures of the optical metasurface may be defined on a surface of the beam combiner optical structure 110 using a photolithographic mask and etched in the surface of the beam combiner optical structure 110 using photolithographic etch processes.

As depicted in FIG. 1, the transmission optical region 112 is proximate the optical transmitter 102. The transmission optical region 112 is configured to receive the transmitted optical signal 106 and generate a collimated transmitted portion 106a and a collimated reference portion 106b of the transmitted optical signal 106. A collimated beam of light is a beam of light wherein all the rays are parallel to each other. The collimated transmitted portion 106a is directed through the beam combiner optical structure 110 at an angle of refraction less than the critical angle of the outer surface 110b of the beam combiner optical structure 110. For example, in some embodiments, the collimated transmitted portion 106a is directed at a refraction angle at or near orthogonal to the inner surface 110a of the beam combiner optical structure 110. Thus, the collimated transmitted portion 106a of the transmitted optical signal 106 passes through the outer surface 110b of the beam combiner optical structure 110 and into the external environment 116.

As further depicted in FIG. 1, the collimated reference portion 106b is directed within the beam combiner optical structure 110 at a refraction angle 115 greater than the critical angle of the outer surface 110b of the beam combiner optical structure 110. Thus, the collimated reference portion 106b of the transmitted optical signal 106 encounters the outer surface 110b at an incident angle 119 greater than the critical angle 118 of the outer surface 110b. For this reason, the collimated reference portion 106b experiences total internal reflection when encountering the outer surface 110b of the beam combiner optical structure 110.

In some embodiments, the transmission optical region 112 may be configured to separate the transmitted optical signal 106 into the collimated transmitted portion 106a and the collimated reference portion 106b based on the polarity of the incident light. In an instance in which the transmission optical region 112 comprises metasurface nanostructures and the metasurface nanostructures are polarization sensitive, the metasurface may be designed to split beams based on polarization. The transmitted portion 106a of the transmitted optical signal 106 may comprise light of a first polarization, while the reference portion 106b comprises light of a second polarization. In an instance in which the target maintains 100% of the polarization of the transmitted portion 106a, this results in perfect efficiency, such that no light is wasted in total internal reflection or as stray light.

As further depicted in FIG. 1, the receiving optical region 114 is proximate the optical receiver 104. The receiving optical region 114 is configured to receive the collimated reference portion 106b of the transmitted optical signal 106 and transmit the reference portion 106b out of the beam combiner optical structure 110 and toward the optical receiver 104 as a reference optical signal 108 for comparison to a returning optical signal (as depicted in FIG. 2). In some embodiments, the receiving optical region 114 is configured to transmit the reference optical signal 108 orthogonal to the inner surface 110a of the beam combiner optical structure 110. The receiving optical region 114 is further configured to focus the reference optical signal 108 toward the optical receiver 104. Focused light is directed to converge at a single point, for example, the optical receiver 104. By focusing the reference optical signal 108, the full field of view of the reference optical signal 108 may be received at the optical receiver.

In some embodiments, the receiving optical region 114 may be configured to direct the optical signals received based on the polarity of the incident light. In an instance in which the receiving optical region 114 comprises metasurface nanostructures and the metasurface nanostructures are polarization sensitive, the metasurface may be designed to direct optical beams based on polarization.

Referring now to FIG. 2, an example returning optical signal 220 reflected off a target object 222 in an external environment 116 and received at the optical receiver 104 of a coherent detection beam combiner system 100 is depicted.

As depicted in FIG. 2, a portion of the transmitted optical signal (e.g., transmitted portion 106a) may reflect off a target object 222. A target object 222 comprises any object, structure, surface, or plurality of objects or structures, for which an optical ranging system is configured to determine a physical property. In one example embodiment, the target object 222 comprises any object within the field-of-view of the coherent detection beam combiner system 100. A physical property may comprise a distance to the target object 222, motion of the target object 222, a speed of the target object 222, presence of a target object 222, material properties of a target object 222, and/or the like.

As further depicted in FIG. 2, the example coherent detection beam combiner system 100 is configured to receive a returning optical signal 220. A returning optical signal 220 comprises any portion of the transmitted portion 106a of the transmitted optical signal 106 reflected off a target object 222 and returning to the coherent detection beam combiner system 100. The coherent detection beam combiner system 100 is configured to determine one or more physical properties of the target object 222 based on mode matching the returning optical signal 220 with the reference optical signal (reference optical signal 108 as depicted in FIG. 1) and analyzing the interference pattern of the mixed optical signal. Mode matching the returning optical signal 220 with the reference optical signal ensures the two optical signals have the same wavefront shape. By ensuring the two signals are mode matched, the coherent detection beam combiner system 100 may detect changes to the returning optical signal 220 due to interactions with a target object 222.

As such, the receiving optical region 114, in addition to the functionality described in relation to FIG. 1, is further configured to transmit the returning optical signal 220 out of the beam combiner optical structure 110 and focus the returning optical signal 220 at the optical receiver 104 for comparison with the reference optical signal 108. In some embodiments, the receiving optical region 114 is configured to transmit the returning optical signal 220 orthogonal to the inner surface 110a of the beam combiner optical structure 110. The receiving optical region 114 is further configured to focus the returning optical signal 220 at the optical receiver 104. By focusing the returning optical signal 220, the full field of view of the returning optical signal 220 may be received at the optical receiver 104.

In some embodiments, the receiving optical region 114 may be configured to direct the optical signals received based on the polarization of the incident light. In an instance in which the receiving optical region 114 comprises metasurface nanostructures and the metasurface nanostructures are polarization sensitive, the metasurface may be designed to direct optical beams based on polarization in conjunction with the transmission optical region 112. For example, in an instance in which the transmission optical region 112 generates the transmitted portion 106a based on polarization, the returning optical signal 220 and the reference optical signal 108 may be recombined based on polarization, e.g., different optical functionalities may be imparted to the reference and returning beams depending on their polarizations.

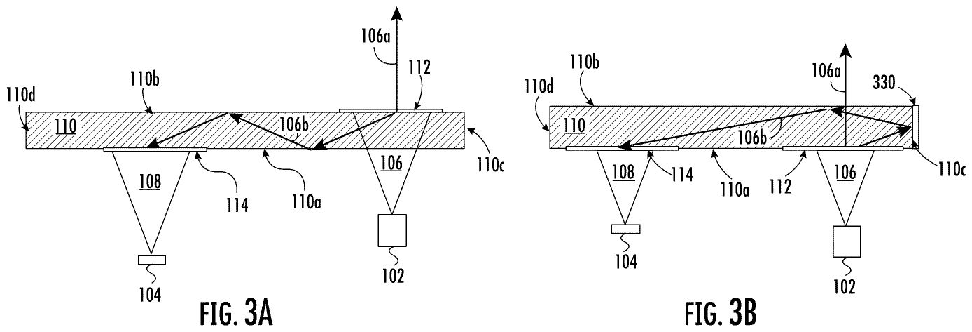

Referring now to FIG. 3A, an example optical region configuration for an example coherent detection beam combiner system. As depicted in FIG. 3A, the transmission optical region 112 is positioned on the outer surface 110b of the beam combiner optical structure 110, opposite the optical transmitter 102. The transmission optical region 112 directs a transmitted portion 106a of the transmitted optical signal 106 through the outer surface 110b of the beam combiner optical structure 110 into an external environment. The reference portion 106b of the transmitted optical signal 106 is totally internally reflected off the inner surface 110a of the beam combiner optical structure 110 and off the outer surface 110b of the beam combiner optical structure 110 before being received at the receiving optical region 114. The receiving optical region 114 directs the reference portion 106b of the transmitted optical signal 106 out of the beam combiner optical structure 110 orthogonal to the inner surface 110a of the beam combiner optical structure 110 as the reference optical signal 108. As further depicted in FIG. 3A, the reference optical signal 108 is focused on the optical receiver 104. Although not depicted in FIG. 3A, any returning optical signal (e.g., returning optical signal 220 as described in relation to FIG. 2) from the external environment received at the receiving optical region 114 is mode-matched with the reference optical signal 108 and is similarly focused on the optical receiver 104.

By positioning the transmission optical region 112 on the outer surface 110b of the beam combiner optical structure 110, the reference portion 106b of the transmitted optical signal 106 experiences an even number of reflections within the beam combiner optical structure 110 before being received at the receiving optical region 114.

A reference portion 106b experiencing an even number of bounces may be beneficial for a number of reasons. One such reason relates to utilizing multiple optical transmitters 102 to scan an external environment. In some embodiments, a plurality of optical transmitters 102 may comprise an array of VCSELs, which depending on the application may emit radiation with a single or multiple longitudinal mode, and be individually or collectively addressable. In such an embodiment, each return signal associated with a different optical transmitter 102 is focused on a different optical receiver 104 specific to the associated optical transmitter 102. In this case, the thickness and deflection angles of the reference signals within the beam combiner optical structure 110 may be carefully designed such that there is a match between the angle and location of each reference beam. If each reference portion 106b experiences an odd number of reflections within the beam combiner optical structure 110, the location of the optical receivers 104 are in opposite order to the optical transmitters 102. The opposite order of the optical receivers 104 may be problematic, for example if the optical transmitters 102 are discrete and not locked together, they will not in general have a long mutual coherence time τᵢⱼ between any given pair {i, j} of discrete sources; then, due to the inverted order of the points imaged on the sensor array as described above, the reference beam originating from source i will overlap with a return beam originating from source j and will not produce a coherent signal on the detector over long-enough timescales for, for example, an FMCW application, hence nullifying the benefit of the presently described coherent detection scheme. Selecting a geometric configuration of the beam combiner optical structure 110 such that each reference portion 106b of each transmitted optical signal 106 experiences an even number of reflections within the beam combiner optical structure 110 enables the optical receivers 104 to be in the same order as the optical transmitters 102.

Referring now to FIG. 3B, another optical region configuration of a beam combiner optical structure 110 in which the reference portion 106b experiences an even number of reflections within the beam combiner optical structure 110 is provided. As depicted in FIG. 3B, the transmission optical region 112 is positioned on the inner surface 110a of the beam combiner optical structure 110, proximate the optical transmitter 102. The receiving optical region 114 is also positioned on the inner surface 110a of the beam combiner optical structure 110, proximate the optical receiver 104. The transmission optical region 112 directs a transmitted portion 106a of the transmitted optical signal 106 at a refraction angle less than the critical angle of the beam combiner optical structure 110. Thus, the transmitted portion 106a passes through the outer surface 110b of the beam combiner optical structure 110 an into an external environment.

The reference portion 106b of the transmitted optical signal 106 is directed toward the transmission end 110c of the beam combiner optical structure 110 proximate the transmission optical region 112. As depicted in FIG. 3B, the reference portion 106b reflects off the transmission end 110c of the beam combiner optical structure 110, and off the outer surface 110b of the beam combiner optical structure 110 before being received at the receiving optical region 114. The receiving optical region 114 directs the reference portion 106b of the transmitted optical signal 106 out of the beam combiner optical structure 110 orthogonal to the inner surface 110a of the beam combiner optical structure 110 as the reference optical signal 108. By directing the reference portion 106b of the transmitted optical signal 106, the reference portion 106b experiences an even number of reflections before arriving at the optical receiver 104.

As further depicted in FIG. 3B, the reference optical signal 108 is focused on the optical receiver 104. Although not depicted in FIG. 3B, any returning optical signal (e.g., returning optical signal 220 as described in relation to FIG. 2) from the external environment received at the receiving optical region 114 is mode-matched with the reference optical signal 108 and is similarly focused on the optical receiver 104.

As further depicted in FIG. 3B, a reflective coating 330 may be placed on the transmission end 110c of the beam combiner optical structure 110. The reflective coating 330 comprises any film, material, structure, or device configured to reflect the reference portion 106b encountering the transmission end 110c. In some embodiments, the reflective coating 330 may be a metallic coating attached to the outer surface of the transmission end 110c of the beam combiner optical structure 110. In some embodiments, the reflective coating 330 may enable total internal reflection in an instance in which the angle of incidence of the reference portion 106b at the transmission end 110c may not be larger than the critical angle of the beam combiner optical structure 110.

Referring now to FIG. 4A, an example optical region configuration for an example coherent detection beam combiner system is provided. As depicted in FIG. 4A, the transmission optical region 112 is positioned on the outer surface 110b of the beam combiner optical structure 110, opposite the optical transmitter 102. The receiving optical region 114 is also positioned on the outer surface 110b of the beam combiner optical structure 110, opposite the optical receiver 104. The transmission optical region 112 directs a transmitted portion 106a of the transmitted optical signal 106 through the outer surface 110b of the beam combiner optical structure 110 into an external environment. The reference portion 106b of the transmitted optical signal 106 is totally internally reflected off the inner surface 110a of the beam combiner optical structure 110 before being received at the receiving optical region 114. The receiving optical region 114 directs the reference portion 106b at an incident angle less than the critical angle of the beam combiner optical structure 110 at the inner surface 110a, such that the transmitted optical signal 106 is transmitted out of the beam combiner optical structure 110 orthogonal to the inner surface 110a of the beam combiner optical structure 110 as the reference optical signal 108. As further depicted in FIG. 4A, the reference optical signal 108 is focused on the optical receiver 104. Although not depicted in FIG. 4A, any returning optical signal (e.g., returning optical signal 220 as described in relation to FIG. 2) from the external environment received at the receiving optical region 114 is mode-matched with the reference optical signal 108 and is similarly focused on the optical receiver 104.

Referring now to FIG. 4B, another optical region configuration of a beam combiner optical structure 110 is provided. As depicted in FIG. 4B, the transmission optical region 112 is positioned on the inner surface 110a of the beam combiner optical structure 110, proximate the optical transmitter 102. The receiving optical region 114 is also positioned on the inner surface 110a of the beam combiner optical structure 110, proximate the optical receiver 104. The transmission optical region 112 directs a transmitted portion 106a of the transmitted optical signal 106 through the outer surface 110b of the beam combiner optical structure 110 into an external environment.

The reference portion 106b of the transmitted optical signal 106 is directed toward the outer surface 110b of the beam combiner optical structure 110 at a refraction angle greater than the critical angle of the beam combiner optical structure 110. Thus, the reference portion 106b is totally internally reflected when encountering the outer surface 110b. As further depicted in FIG. 4B, the reference portion 106b reflects off the inner surface 110a of the beam combiner optical structure 110, and off the outer surface 110b of the beam combiner optical structure 110 before being received at the receiving optical region 114.

As further depicted in FIG. 4B, a reflective coating 440 is placed on a portion of the inner surface 110a of the beam combiner optical structure 110. The reflective coating 440 comprises any film, material, structure, or device configured to reflect the reference portion 106b encountering the portion of the inner surface 110a. In some embodiments, the reflective coating 440 may be a metallic coating attached to the inner surface 110a of the beam combiner optical structure 110. In some embodiments, the reflective coating 440 may enable total internal reflection in an instance in which the angle of incidence of the reference portion 106b at the inner surface may not be larger than the critical angle of the beam combiner optical structure 110. Although not depicted, in some embodiments, the reference portion 106b may experience a plurality of reflections off the inner surface 110a of the beam combiner optical structure 110 before encountering the receiving optical region 114.

The receiving optical region 114 directs the reference portion 106b of the transmitted optical signal 106 out of the beam combiner optical structure 110 orthogonal to the inner surface 110a of the beam combiner optical structure 110 as the reference optical signal 108.

As further depicted in FIG. 4B, the reference optical signal 108 is focused on the optical receiver 104. Although not depicted in FIG. 4B, any returning optical signal (e.g., returning optical signal 220 as described in relation to FIG. 2) from the external environment received at the receiving optical region 114 is mode-matched with the reference optical signal 108 and is similarly focused on the optical receiver 104.

Referring now to FIG. 4C, another optical region configuration of a beam combiner optical structure 110 is provided. As depicted in FIG. 4C, the transmission optical region 112 is positioned on the inner surface 110a of the beam combiner optical structure 110, proximate the optical transmitter 102. The receiving optical region 114 is also positioned on the inner surface 110a of the beam combiner optical structure 110, proximate the optical receiver 104. Each of the ends (e.g., transmission end 410c, receiving end 410d) of the beam combiner optical structure 110 are at oblique angles relative to the inner surface 110a and the outer surface 110b of the beam combiner optical structure 110. As used herein, an oblique angle refers to any angle that is not ninety degrees. By positioning one or more of the ends of the beam combiner optical structure 110 at an oblique angle, additional paths of the reference portion 106b of the transmitted optical signal 106 may be obtained.

As depicted in FIG. 4C, the transmission optical region 112 directs a transmitted portion 106a of the transmitted optical signal 106 at a refraction angle less than the critical angle of the beam combiner optical structure 110 at the outer surface 110b. Thus, the transmitted portion 106a of the transmitted optical signal 106 travels through the outer surface 110b of the beam combiner optical structure 110 into an external environment.

The reference portion 106b of the transmitted optical signal 106 is directed toward the transmission end 410c of the beam combiner optical structure 110 at a refraction angle greater than the critical angle of the beam combiner optical structure 110 at the transmission end 410c. Thus, the reference portion 106b is totally internally reflected when encountering the transmission end 410c. As further depicted in FIG. 4C, the reference portion 106b reflects off the outer surface 110b, off the inner surface 110a, back off the outer surface 110b, and off the receiving end 410d before being received at the receiving optical region 114.

The receiving optical region 114 directs the reference portion 106b of the transmitted optical signal 106 out of the beam combiner optical structure 110 orthogonal to the inner surface 110a of the beam combiner optical structure 110 as the reference optical signal 108.

As further depicted in FIG. 4C, the reference optical signal 108 is focused on the optical receiver 104. Although not depicted in FIG. 4C, any returning optical signal (e.g., returning optical signal 220 as described in relation to FIG. 2) from the external environment received at the receiving optical region 114 is mode-matched with the reference optical signal 108 and is similarly focused on the optical receiver 104.

Referring now to FIG. 4D, another optical region configuration of a beam combiner optical structure 110 is provided. As depicted in FIG. 4D, the transmission optical region 112 is positioned on the inner surface 110a of the beam combiner optical structure 110, proximate the optical transmitter 102. The receiving optical region 114 is also positioned on the inner surface 110a of the beam combiner optical structure 110, proximate the optical receiver 104. The outer surface 110b of the beam combiner optical structure 110 is coated with a patterned reflective coating 450.

As depicted in FIG. 4D, the transmission optical region 112 directs a transmitted portion 106a of the transmitted optical signal 106 at refraction angle less than the critical angle of the beam combiner optical structure 110 at the outer surface 110b. Thus, the transmitted portion 106a of the transmitted optical signal 106 travels through the outer surface 110b of the beam combiner optical structure 110 into an external environment.

The reference portion 106b is directed towards surface 110b and the patterned reflective coating 450, such that the reference portion 106b is reflected upon contact with surface 110b even when the angle of incidence of the reference portion 106b relative to the outer surface 110b is not greater than the angle at which Total Internal Reflection occurs for the given device structure. Upon contact with the outer surface 110b, the reference portion 106b is reflected towards the receiving optical region 114.

The receiving optical region 114 directs the reference portion 106b of the transmitted optical signal 106 out of the beam combiner optical structure 110 orthogonal to the inner surface 110a of the beam combiner optical structure 110 as the reference optical signal 108.

As further depicted in FIG. 4D, the reference optical signal 108 is focused on the optical receiver 104. Although not depicted in FIG. 4D, any returning optical signal (e.g., returning optical signal 220 as described in relation to FIG. 2) from the external environment received at the receiving optical region 114 is mode-matched with the reference optical signal 108 and is similarly focused on the optical receiver 104. Furthermore, the patterned reflective coating 450 is patterned such that the returning optical signal is unobstructed upon contact with surface 110b.

Referring now to FIG. 4E, another optical region configuration of a beam combiner optical structure 110 is provided. As depicted in FIG. 4E, the transmission optical region 112 is positioned on the inner surface 110a of the beam combiner optical structure 110, proximate the optical transmitter 102. The receiving optical region 114 is also positioned on the inner surface 110a of the beam combiner optical structure 110, proximate the optical receiver 104. The outer surface 110b of the beam combiner optical structure 110 is uniformly coated with an optical coating 460, for example a multilayer dielectric coating, such that the optical coating 460 has high transmittance value of normal-incidence or low Angle of Incidence (AOI) radiation at the wavelength or wavelengths emitted by the optical transmitter 102, but low transmittance value and high reflectance for high AOI beams at the same working wavelength.

As depicted in FIG. 4E, the transmission optical region 112 directs a transmitted portion 106a of the transmitted optical signal 106 at refraction angle less than the critical angle of the beam combiner optical structure 110 at the outer surface 110b, and at low AOI relative to the coated outer surface 110b. Thus, the transmitted portion 106a of the transmitted optical signal 106 travels through the outer surface 110b of the beam combiner optical structure 110, through the optical coating 460 and into an external environment.

The reference portion 106b is directed towards outer surface 110b and its optical coating 460, such that it is partially or fully reflected upon contact with the outer surface 110b even when its angle of incidence is not greater than the angle at which Total Internal Reflection occurs for the given device structure. Upon contact with the outer surface 110b, the reference portion 106b is reflected towards the receiving optical region 114.

The receiving optical region 114 directs the reference portion 106b of the transmitted optical signal 106 out of the beam combiner optical structure 110 orthogonal to the inner surface 110a of the beam combiner optical structure 110 as the reference optical signal 108.

As further depicted in FIG. 4E, the reference optical signal 108 is focused on the optical receiver 104. Although not depicted in FIG. 4E, any returning optical signal (e.g., returning optical signal 220 as described in relation to FIG. 2) from the external environment received at the receiving optical region 114 is mode-matched with the reference optical signal 108 and is similarly focused on the optical receiver 104.

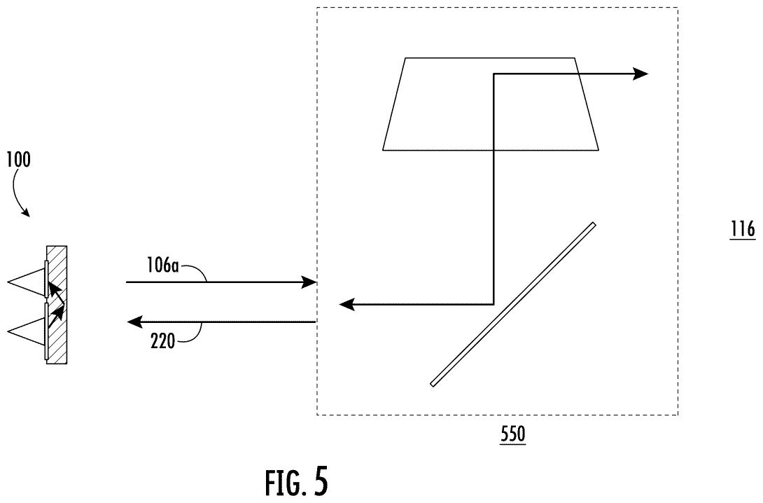

Referring now to FIG. 5, an example coherent detection beam combiner system 100 configured to operate in accordance with a scanning mechanism 550 is depicted. As depicted in FIG. 5, the transmitted portion 106a of the transmitted optical signal (e.g., transmitted optical signal 106 as described in relation to FIG. 1) is received by a scanning mechanism 550. As further depicted in FIG. 5, the returning optical signal 220 is received at the coherent detection beam combiner system 100 through the scanning mechanism 550.

As depicted in FIG. 5, the scanning mechanism 550 may be positioned external to the beam combiner optical structure. A scanning mechanism 550 comprises any optical components, including mirrors, lenses, and other optical devices configured to receive an optical signal and direct the optical signal to a specified location in a field-of-view. A scanning mechanism 550 may be utilized to increase the field-of-view of a coherent detection beam combiner system 100. For example, the scanning mechanism 550 may be configured to direct the transmitted portion 106a of the transmitted optical signal in a pattern into the external environment 116.

In some embodiments, the scanning mechanism 550 may direct the transmitted portion 106a into the external environment 116 in a raster pattern. A raster pattern is a process by which the transmitted portion 106a is directed into an external environment 116 sequentially in a first direction, one line at a time. After completion of a line, the pattern moves to the next line, in a second direction. The pattern continues until the transmitted portion 106a has been directed to each location within the field-of-view.

In some embodiments, the scanning mechanism 550 may comprise one or more MEMS mirrors. The one or more MEMS mirrors are configured to direct the optical output generated by the coherent detection beam combiner system 100 to a particular location within the field-of-view. For example, a scanning mechanism 550 may comprise two MEMS mirrors configured to steer the optical output along two axes (e.g., horizontal and vertical). In a raster pattern, the horizontal MEMS mirror may move quickly to scan the pixels across a horizontal line of the display image while the vertical MEMS mirror moves slower relative to the horizontal MEMS mirror.

Although depicted separate from the coherent detection beam combiner system 100 in FIG. 5, in some embodiments, the scanning mechanism 550 may be integrated with the coherent detection beam combiner system 100. For example, the scanning mechanism 550 may be positioned on the outer surface of the coherent detection beam combiner system 100.

By incorporating the scanning mechanism 550 after the transmitted portion 106a of the transmitted optical signal 106 has passed through the beam combiner optical structure, any optical region configuration of the beam combiner optical structure may be used.

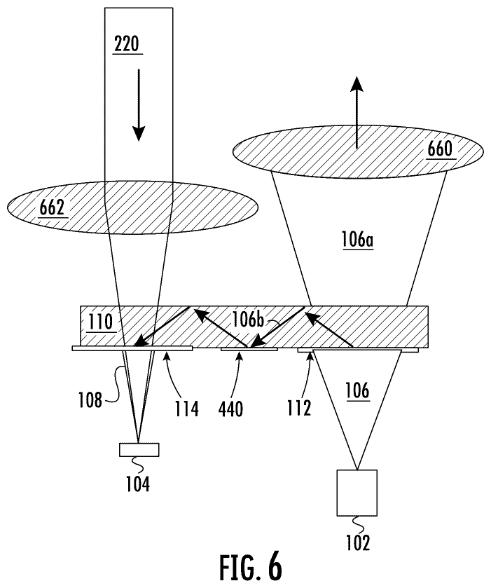

Referring now to FIG. 6, an example coherent detection beam combiner system 600 is provided. As depicted in FIG. 6, a collimator 660 and a lens 662 are integrated with the coherent detection beam combiner system 600 separate from the beam combiner optical structure 110.

As depicted in FIG. 6, the collimator 660 is separated from the transmission optical region 112 of the beam combiner optical structure 110. A collimator 660 comprises any optical device configured to receive an optical signal (e.g., transmitted portion 106a) and generate an output optical signal having parallel beams. As such, the output optical signal of the collimator 660 may exhibit a uniform cross section as it is projected in space. By separating the collimator from the beam combiner optical structure 110, the transmission optical region 112 may no longer be required to collimate the transmitted optical signal 106. Thus, the transmission optical region 112 may be simplified.

As further depicted in FIG. 6, the lens 662 is separated from the receiving optical region 114 of the beam combiner optical structure 110. The lens 662 comprises any optical device configured to focus the returning optical signal 220 onto the optical receiver 104. The lens 662 is configured to focus the returning optical signal 220 such that the returning optical signal 220 is mode-matched with the reference portion 106b of the transmitted optical signal 106 focused by the receiving optical region 114 of beam combiner optical structure 110.

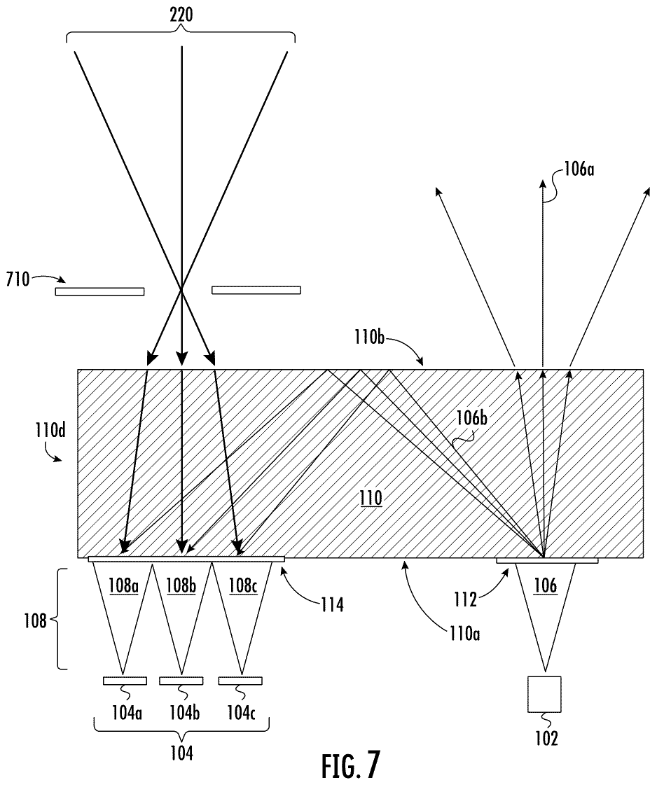

Referring now to FIG. 7, another optical configuration of a beam combiner optical structure 110 is provided. As depicted in FIG. 7, the transmission optical region 112 is positioned on the inner surface 110a of the beam combiner optical structure 110, proximate the optical transmitter 102. The receiving optical region 114 is also positioned on the inner surface 110a of the beam combiner optical structure 110, proximate an optical receiver 104 split into any number of distinct regions, for example regions 104a, 104b, 104c, such that the signal within each region 104a, 104b, 104c may be monitored independently.

As depicted in FIG. 7, the transmission optical region 112 splits the transmitted portion 106a of the transmitted optical signal 106 into multiple distinct beams each at refraction angle less than the critical angle of the beam combiner optical structure 110 at the outer surface 110b. Thus, the multiple distinct beams of the transmitted portion 106a of the transmitted optical signal 106 travel through the outer surface 110b of the beam combiner optical structure 110 and into an external environment.

The reference portions 106b, also split into multiple beams, are directed towards surface 110b, where each component beam travels at an angle greater than the angle of Total Internal Reflection with respect to surface 110b. Upon contact with surface 110b, the reference portions 106b are reflected towards the receiving optical region 114.

The receiving optical region 114 directs each beam comprising the reference portions 106b of the transmitted optical signal 106 out of the beam combiner optical structure 110 orthogonal to the inner surface 110a of the beam combiner optical structure 110 as the reference optical signal 108, composed of multiple beams herein labeled, for example reference optical signal 108a, 108b, 108c.

As further depicted in FIG. 7, each beam constituting the reference optical signal 108 is focused on the optical receiver 104, such that each beam is incident on exactly one distinct and exclusive segment of the optical sensor, for example, regions 104a, 104b, 104c respectively. Furthermore, any returning optical signal (e.g., returning optical signal 220 as described in relation to FIG. 2), also split in separate beams, incident on structure 110 from the external environment at different angles, is modified by the receiving optical region 114, where each beam is mode-matched with one of the beams comprising the reference optical signal 108, and is similarly focused on the optical receiver 104, such that each separate beam is incident on a segment of the optical sensor. Since all beams emitted by transmission optical region 112 originate from a single reference transmitted optical signal 106, they will all be mutually coherent, therefore any given beam comprising the reference portions 106b will be suitably coherent with any beam comprising the returning optical signal 220; furthermore, splitting optical receiver 104 into regions corresponding to each beam will ensure that each coherent signal deriving from combining the reference and returning beams will be detected separately. The architecture described thus enables simultaneous multi-zone coherent detection with no issues stemming from parity or lack thereof in the number of reflections experienced by the reference signal, and without requiring the locking of multiple sources together.

As further depicted in FIG. 7, an aperture stop 710 may be placed externally or internally to the beam combiner optical structure 110, in order to facilitate the spatial positioning of the beams of the returning optical signal 220 on the receiving optical region 114, which in turn may improve the mode-matching between the returning optical signal 220 and the reference optical signal 108.

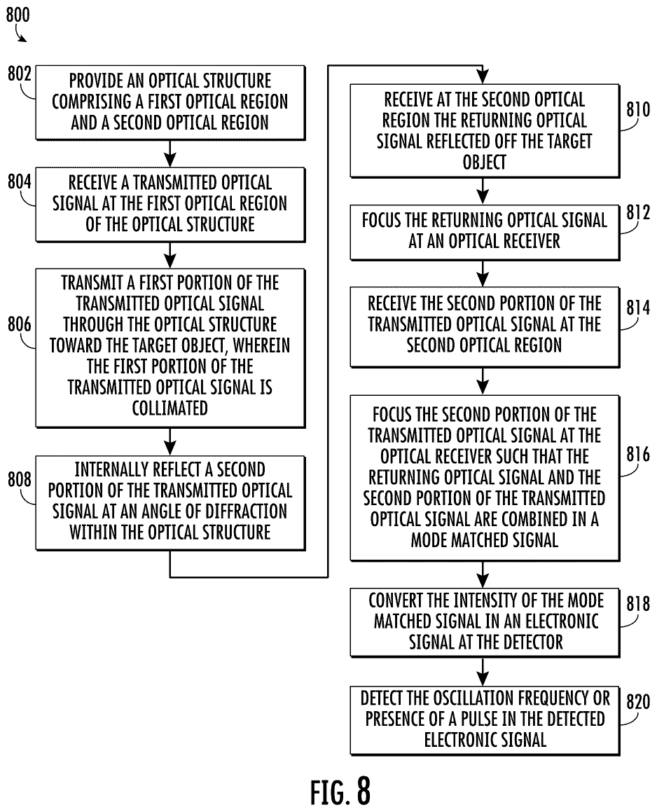

Referring now to FIG. 8, an example process 800 detecting pulses in a returning optical signal (e.g., returning optical signal 220) is provided. At block 802, an optical structure (e.g., beam combiner optical structure 110) comprising a first optical region (e.g., transmission optical region 112) and a second optical region (e.g., receiving optical region 114) is provided at a coherent detection beam combiner system (e.g., coherent detection beam combiner system 100). The optical structure comprises any transparent or semi-transparent single structure comprising at least a first optical region and a second optical region. One or more of the first optical region and the second optical region may comprise diffractive optic techniques to generate a diffractive light pattern. For example, in some embodiments, an optical metasurface comprising a plurality of nanostructures may be defined on one or more surfaces of the optical structure.

At block 804, a transmitted optical signal (e.g., transmitted optical signal 106) is received at the first optical region of the beam combiner optical structure. A transmitted optical signal may be generated by an optical transmitter (e.g., optical transmitter 102) and directed toward the first optical region of the beam combiner optical structure. In some embodiments, the transmitted optical signal may comprise a continuous wave that is frequency modulated over time, typically in a linear chirp pattern. In some embodiments, a plurality of optical transmitters may generate a plurality of transmitted optical signals. A plurality of optical signals may be utilized to increase the field-of-view of the coherent detection beam combiner system, determine physical properties of target objects within the external environment, or the like.

At block 806, a first portion (e.g., transmitted portion 106a) of the transmitted optical signal is transmitted through the beam combiner optical structure toward the target object, wherein the first portion of the transmitted optical signal is collimated. The first optical region may direct the first portion of the transmitted optical signal such that the first portion transmits through the optical structure and into an external environment. For example, the first optical region may refract the first portion of the transmitted optical signal at a refraction angle less than the critical angle of the beam combiner optical structure. In addition, the first optical region may be configured to collimate the first portion of the transmitted optical signal.

At block 808, a second portion (e.g., reference portion 106b) of the transmitted optical signal is internally reflected at an angle of diffraction within the beam combiner optical structure. The first optical region may be further configured to direct a second portion of the transmitted optical signal at a diffraction angle larger than the critical angle of the beam combiner optical structure at the incident surface. By refracting the second portion of the transmitted optical signal at a diffraction angle larger than the critical angle, the second portion of the transmitted optical signal is totally internally reflected when encountering the incident boundary of the beam combiner optical structure (e.g., outer surface 110b). In some embodiments, the first portion and the second portion may divided based on amplitude, for example, directing the light based on the position of the transmitted optical signal on the surface of the first optical region. In some embodiments, the first portion and the second portion may be divided based on polarization. For example, the structures comprising the first optical region may direct the optical signal differently based on the polarization of the optical signal.

At block 810, a returning optical signal (e.g., returning optical signal 220) reflected off the target object (e.g., target object 222) is received at the second optical region (e.g., receiving optical region 114). The transmitted portion of the transmitted optical signal may reflect off one or more objects in the external environment and return to the coherent detection beam combiner system as a returning optical signal.

At block 812, the returning optical signal is focused at an optical receiver. The second optical region is configured to focus the returning optical signal at the optical receiver. The optical receiver generates an electrical output based on the properties of the optical signal received.

At block 814, the second portion of the transmitted optical signal is received at the second optical region. The second portion of the transmitted optical signal, or reference portion, is internally reflected through the optical structure. The optical path of the second portion of the transmitted optical signal is determined based on the geometric configuration of the optical structure, the optical region configurations, and the refractive index of the optical structure. For example, in some embodiments, the second portion of the transmitted optical signal may follow an optical path with an even number of reflections. In some embodiments, the second portion of the transmitted optical signal may follow an optical path with an odd number of reflections.

At block 816, the second portion of the transmitted optical signal is focused at the optical receiver such that the returning optical signal and the second portion of the transmitted optical signal are combined in a mode matched signal. To be mode matched, the returning optical signal and the second portion of the transmitted optical signal (e.g., reference optical signal 108) have the same wavefront shape.

At block 818, the mode matched signal is detected by a detector, such as a photodiode, imaging array, SPAD array or the like. The combined reference optical signal and returning optical signal generate an irradiance footprint over the detector, which is collected and converted into an electronic signal, for example a current or voltage, by the detector circuitry.

At block 820, the electronic signal is analyzed to extract information about the target. For example, in a pulsed ToF system, the presence or absence of one or more pulses in this signal, and their delay with respect to an internal time reference, may be used to infer the position, proximity, and/or speed of a target object; in an FMCW LiDAR system, the frequency at which the electronic signal oscillates may be may be used to infer the position, proximity, and/or speed of a target object determined; and so on for other coherent-detection schemes. In some embodiments, material properties of the target object may be determined based on the observed characteristics of the signal.

While this detailed description has set forth some embodiments of the present invention, the appended claims cover other embodiments of the present invention which differ from the described embodiments according to various modifications and improvements. For example, one skilled in the art may recognize that such principles may be applied to any electronic device that generates a reference signal for comparison to a transmitted signal. For example, LiDAR systems, time-of-flight sensors, 3D mapping systems, laser-based distance measurement devices, satellite tracking systems, and the like.

Within the appended claims, unless the specific term “means for” or “step for” is used within a given claim, it is not intended that the claim be interpreted under 35 U.S.C. 112, paragraph 6.

Use of broader terms such as “comprises,” “includes,” and “having” should be understood to provide support for narrower terms such as “consisting of,” “consisting essentially of,” and “comprised substantially of” Use of the terms “optionally,” “may,” “might,” “possibly,” and the like with respect to any element of an embodiment means that the element is not required, or alternatively, the element is required, both alternatives being within the scope of the embodiment(s). Also, references to examples are merely provided for illustrative purposes, and are not intended to be exclusive.

1. A detection beam combiner system comprising:
an optical transmitter configured to transmit an optical signal toward a target object;
an optical receiver configured to receive the optical signal reflected off the target object and a reference optical signal; and
a beam combiner optical structure positioned between the optical transmitter and the target object, and configured to receive the optical signal, the beam combiner optical structure comprising:
a first optical region configured to:
transmit a first portion of the optical signal through the beam combiner optical structure toward the target object, and
internally reflect a second portion of the optical signal within the beam combiner optical structure; and
a second optical region configured to:
transmit the optical signal reflected off the target object to the optical receiver, and
transmit the second portion of the optical signal out of the beam combiner optical structure, toward the optical receiver, as the reference optical signal.

2. The detection beam combiner system of claim 1, wherein the first optical region and the second optical region each comprise an optical metasurface.

3. The detection beam combiner system of claim 1, wherein the first portion of the optical signal is collimated.

4. The detection beam combiner system of claim 1, wherein the second portion of the optical signal is directed by the first optical region at a refraction angle larger than a total internal reflection limit for the beam combiner optical structure.

5. The detection beam combiner system of claim 4, wherein the second optical region directs the second portion of the optical signal at an opposite refraction angle relative to the refraction angle, such that the reference optical signal is propagated orthogonally relative to the beam combiner optical structure.

6. The detection beam combiner system of claim 1, wherein the reference optical signal and the optical signal are both focused towards the optical receiver by the second optical region.

7. The detection beam combiner system of claim 1, wherein the optical signal is a frequency-modulated continuous-wave signal.

8. The detection beam combiner system of claim 1, further comprising:
a scanning mechanism configured to scan the first portion of the optical signal across a field-of-view.

9. The detection beam combiner system of claim 1, the beam combiner optical structure comprising:
a first surface proximate the optical transmitter; and
a second surface opposite the first surface.

10. The detection beam combiner system of claim 9, wherein the first optical region and the second optical region are both positioned on the first surface.

11. The detection beam combiner system of claim 9, wherein the second surface of the beam combiner optical structure comprises the first optical region, and the first surface of the beam combiner optical structure comprises the second optical region.

12. The detection beam combiner system of claim 9, the beam combiner optical structure further comprising:
a first end proximate the first optical region; and
a second end proximate the second optical region;
wherein the first optical region directs the first portion of the optical signal toward the first end, and
wherein the first portion of the optical signal experiences an even number of reflections within the beam combiner optical structure before arriving at the second optical region.

13. The detection beam combiner system of claim 12, wherein the first end of the beam combiner optical structure further comprises a reflective coating.

14. The detection beam combiner system of claim 12, wherein the first end is non-orthogonal to the first surface.

15. The detection beam combiner system of claim 9, further comprising:
a patterned reflecting coating on the second surface patterned such that the second portion of the optical signal intersects the patterned reflective coating, the first portion of the optical signal does not intersect the patterned reflective coating, and at least a portion of the optical signal is received through the second surface at the second optical region,
wherein the second portion of the optical signal is reflected by the patterned reflective coating.

16. The detection beam combiner system of claim 9, further comprising an optical coating on the second surface, wherein a transmittance value of the optical coating varies according to an angle of incidence of an incident optical signal, wherein the second portion of the optical signal is reflected by the optical coating, and wherein the first portion of the optical signal is transmitted through the optical coating.

17. The detection beam combiner system of claim 9, wherein the first optical region of the beam combiner optical structure is further configured to generate a plurality of transmitted optical beams comprising the first portion of the optical signal, and a plurality of reflected optical beams comprising the second portion of the optical signal, and wherein the optical signal comprises a plurality of returning optical beams, the optical receiver of the detection beam combiner system further comprising:
a plurality of regions, wherein each region of the plurality of regions simultaneously receives at least one pair comprising a returning optical beam of the plurality of reflected optical beams and a reference optical beam of the plurality of reflected optical beams;
wherein the at least one pair is combined in an independent, mode-matched signal at the second optical region, and directed toward a corresponding region of the plurality of regions.

18. The detection beam combiner system of claim 1, wherein the detection beam combiner system comprises a coherent detection beam combiner system.

19. A beam combiner optical structure, comprising:
a first optical region configured to:
transmit a first portion of an optical signal received at the first optical region through the beam combiner optical structure toward a target object, and
internally reflect a second portion of the optical signal within the beam combiner optical structure; and
a second optical region configured to:
transmit the first portion of the optical signal reflected off the target object through the beam combiner optical structure, and
transmit the second portion of the optical signal out of the beam combiner optical structure.

20. A method for detecting pulses in an optical signal reflected off a target object, the method comprising:
providing a beam combiner optical structure comprising a first optical region and a second optical region;
receiving the optical signal at the first optical region of the beam combiner optical structure;
transmitting a first portion of the optical signal through the beam combiner optical structure toward the target object, wherein the first portion of the optical signal is collimated;
internally reflecting a second portion of the optical signal at an angle of diffraction within the beam combiner optical structure;
receiving at the second optical region the first portion of the optical signal reflected off the target object;
focusing the optical signal at an optical receiver;
receiving the second portion of the optical signal at the second optical region;
focusing the second portion of the optical signal at the optical receiver such that the optical signal and the second portion of the optical signal are combined in a mode matched signal;
converting a light intensity of the mode matched signal into an electronic signal by an optical detector and associated circuitry; and
detecting a pulse in the mode matched signal.
